(19) United States
(12) Patent Application Publication
(10) Pub. No.: US 2025/0175411 A1
(43) Pub. Date: May 29, 2025

(54) PATH PROVISIONING FOR DISTANCE VECTOR ROUTING PROTOCOL USING PRIME PATH PRODUCTS AND PATH PROVISIONING FOR DISTANCE VECTOR ROUTING PROTOCOL USING PRIME PATH PRODUCTS

(71) Applicant: RTX BBN Technologies, Inc., Cambridge, MA (US)

(72) Inventors: Colin Fumito Funai, Whiteland, IN (US); Benjamin Montgomery, Westbrook, ME (US); Brian Jeffrey Basnight, Nokomis, FL (US)

(21) Appl. No.: 18/960,350

(22) Filed: Nov. 26, 2024

Related U.S. Application Data
(60) Provisional application No. 63/603,321, filed on Nov. 28, 2023.

(51) Int. Cl. H04L 45/122; H04L 45/02; H04L 45/302

(52) U.S. Cl. CPC H04L 45/122; H04L 45/02

(57) ABSTRACT

A system may include a network comprising a set of nodes. The system may include a processor and a memory, wherein the memory includes instructions stored thereon that, when executed by the processor, cause the processor to perform operations comprising. The system may assign, with respect to each node of the set of nodes, a node identifier comprising a prime number unique to the node. The system may route a packet from a source node of the set of nodes to a destination node of the set of nodes, based on one or more of the node identifiers.

### CROSS-REFERENCE TO RELATED APPLICATIONS

This application claims the benefit of U.S. Patent Application Ser. No. 63/603,321, filed Nov. 28, 2023, the disclosure of which is incorporated herein by reference in its entirety.

### BACKGROUND

Exemplary embodiments of the present disclosure pertain to the art of provisioning and balancing paths in wireless ad hoc networks.

Provisioning paths in wireless ad hoc networks can be difficult with most protocols balancing the amount of available throughput to support certain types of packets compared to other types of packets.

### BRIEF DESCRIPTION

Disclosed are systems and techniques capable of effective provisioning and balancing of loads in wireless ad hoc networks. The systems and techniques described herein support effective provisioning and balancing of the amount of available throughput in a wireless ad hoc network with respect to a certain type of packets (e.g., support discovery/support and network maintenance packets) and another type of packets (e.g., relatively meaningful data packets).

In some embodiments, the systems and techniques described herein may include using Prime Path Products (PPP) as a means of provisioning data paths in a wireless network using a single numeric value. The provisioning in accordance with one or more embodiments of the present disclosure can operate without being directly tied to any particular radio/protocol and, in some aspects, only requires that each of the participating nodes have a unique node id (i.e., identifier) that is a prime number.

In some embodiments, the systems and techniques described herein may include using Prime Path Products (PPP) as a means of balancing data load paths in a wireless network using a single numeric value. Similar to the features described herein with respect to provisioning data paths, the balancing in accordance with one or more embodiments of the present disclosure may be implemented without being directly tied to any particular radio/protocol and, in some aspects, only requires that each of the participating nodes have a unique node id that is a prime number.

Example embodiments of the present disclosure are directed to a system including: a network including a set of nodes; a processor and a memory, wherein the memory includes instructions stored thereon that, when executed by the processor, cause the processor to perform operations including: assigning, with respect to each node of the set of nodes, a node identifier including a prime number unique to the node; and routing a packet from a source node of the set of nodes to a destination node of the set of nodes, based on one or more of the node identifiers.

In any one or combination of the embodiments disclosed herein, the operations further include: generating distance vectors associated with candidate paths from the source node to the destination node, wherein generating the distance vectors is based on prime numbers respectively associated with candidate nodes which are included in the set of nodes and included in the candidate paths, wherein routing the packet is based on the distance vectors.

In any one or combination of the embodiments disclosed herein, the operations further include: determining, for each candidate path of the candidate paths, a prime path product based on the prime numbers respectively associated with the candidate nodes included in the candidate path, wherein the distance vectors associated with the candidate paths are based on the prime path products associated with the candidate paths.

In any one or combination of the embodiments disclosed herein, the operations further include: determining, for each candidate path of the candidate paths, a quality of service cost and a topology based on the prime path product associated with the candidate path, wherein routing the packet is based on the quality of service costs, the topologies, or both of the candidate paths.

In any one or combination of the embodiments disclosed herein, the operations further include: determining, for each candidate path of candidate paths from the source node to the destination node, a prime path product based on the prime numbers respectively associated with the candidate nodes included in the candidate path; and determining, from among the candidate paths, a set of load balancing paths configured to provide a greatest amount of load balancing of data flow from the source node to the destination node, wherein routing the packet includes routing the packet from the source node to the destination node, via one or more load balancing paths of the set of load balancing paths.

In any one or combination of the embodiments disclosed herein, the operations further include: embedding a prime path product value in a header of the packet; modifying the prime path product value in the header of the packet, based on the node identifier of a node via which the packet traverses; and maintaining the network based on the modified prime path product value.

In any one or combination of the embodiments disclosed herein, the operations further include: receiving, at a node of the set of nodes, the packet; retrieving, in response to determining the packet is a discovery packet, a prime path product associated with the packet; determining, at the node, whether the prime number included in the node identifier associated with the node is a factor of the prime path product; and one of: updating a routing table associated with the network, in response to determining the prime number is a factor of the prime path product; or proceeding to a routing loop associated with routing the packet, in response to determining the prime number is not a factor of the prime path product.

In any one or combination of the embodiments disclosed herein, the operations further include: receiving, at a node of the set of nodes, the packet; determining, in response to determining the packet is a data packet, whether the packet is part of an existing data flow; determining, in response to determining the packet is part of the existing data flow, whether to continue using an existing route associated with the existing data flow; and routing the packet using the existing route or a different route, based on the determination of whether to continue using the existing route.

In any one or combination of the embodiments disclosed herein, the operations further include: receiving, at a node of the set of nodes, the packet; determining, in response to determining the packet is a data packet, whether the packet is part of an existing data flow; determining, in response to determining the packet is not part of the existing data flow, one or more candidate paths for reaching the destination node, wherein determining the one or more candidate paths is based on respective prime path products associated with the one or more candidate paths; registering a data flow associated with the one or more candidate paths; and routing the packet based on the data flow and the one or more candidate paths.

In any one or combination of the embodiments disclosed herein, the system includes a routing table including the node identifiers assigned with respect to the set of nodes.

Example embodiments of the present disclosure are directed to a method including: assigning, with respect to each node of the set of nodes, a node identifier including a prime number unique to the node; and routing a packet from a source node of the set of nodes to a destination node of the set of nodes, based on one or more of the node identifiers.

In any one or combination of the embodiments disclosed herein, the method further includes: generating distance vectors associated with candidate paths from the source node to the destination node, wherein generating the distance vectors is based on prime numbers respectively associated with candidate nodes which are included in the set of nodes and included in the candidate paths, wherein routing the packet is based on the distance vectors.

In any one or combination of the embodiments disclosed herein, the method further includes: determining, for each candidate path of the candidate paths, a prime path product based on the prime numbers respectively associated with the candidate nodes included in the candidate path, wherein the distance vectors associated with the candidate paths are based on the prime path products associated with the candidate paths.

In any one or combination of the embodiments disclosed herein, the method further includes: determining, for each candidate path of the candidate paths, a quality of service cost and a topology based on the prime path product associated with the candidate path, wherein routing the packet is based on the quality of service costs, the topologies, or both of the candidate paths.

In any one or combination of the embodiments disclosed herein, the method further includes: determining, for each candidate path of candidate paths from the source node to the destination node, a prime path product based on the prime numbers respectively associated with the candidate nodes included in the candidate path; and determining, from among the candidate paths, a set of load balancing paths configured to provide a greatest amount of load balancing of data flow from the source node to the destination node, wherein routing the packet includes routing the packet from the source node to the destination node, via one or more load balancing paths of the set of load balancing paths.

In any one or combination of the embodiments disclosed herein, the method further includes: embedding a prime path product value in a header of the packet; modifying the prime path product value in the header of the packet, based on the node identifier of a node via which the packet traverses; and maintaining the network based on the modified prime path product value.

In any one or combination of the embodiments disclosed herein, the method further includes: receiving, at a node of the set of nodes, the packet; retrieving, in response to determining the packet is a discovery packet, a prime path product associated with the packet; determining, at the node, whether the prime number included in the node identifier associated with the node is a factor of the prime path product; and one of: updating a routing table associated with the network, in response to determining the prime number is a factor of the prime path product; or proceeding to a routing loop associated with routing the packet, in response to determining the prime number is not a factor of the prime path product.

In any one or combination of the embodiments disclosed herein, the method further includes: receiving, at a node of the set of nodes, the packet; determining, in response to determining the packet is a data packet, whether the packet is part of an existing data flow; determining, in response to determining the packet is part of the existing data flow, whether to continue using an existing route associated with the existing data flow; and routing the packet using the existing route or a different route, based on the determination of whether to continue using the existing route.

In any one or combination of the embodiments disclosed herein, the method further includes: receiving, at a node of the set of nodes, the packet; determining, in response to determining the packet is a data packet, whether the packet is part of an existing data flow; determining, in response to determining the packet is not part of the existing data flow, one or more candidate paths for reaching the destination node, wherein determining the one or more candidate paths is based on respective prime path products associated with the one or more candidate paths; registering a data flow associated with the one or more candidate paths; and routing the packet based on the data flow and the one or more candidate paths.

In any one or combination of the embodiments disclosed herein, the node identifiers are stored to a routing table.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

The following descriptions should not be considered limiting in any way. With reference to the accompanying drawings, like elements are numbered alike:

FIG. 1 shows an example data flow diagram of how PPP may operate in one embodiment;

FIG. 2 is a data flow diagram of illustrating how paths can be provisioned using PPP;

FIGS. 3 and 4 are compressed versions of the data flow diagram of FIG. 2;

FIG. 5 is flow chart showing an example method of provisioning according to one embodiment;

FIG. 6 is a data flow diagram showing how data flow can managed;

FIG. 7 is a data flow diagram showing how data flow can managed with some broken paths;

FIG. 8 is a block diagram of a distributed computer system in accordance with one or more embodiments of the present disclosure; and

FIG. 9 illustrates an example flowchart of a method in accordance with one or more embodiments of the present disclosure.

### DETAILED DESCRIPTION

A detailed description of one or more embodiments of the disclosed apparatus and method are presented herein by way of exemplification and not limitation with reference to the Figures.

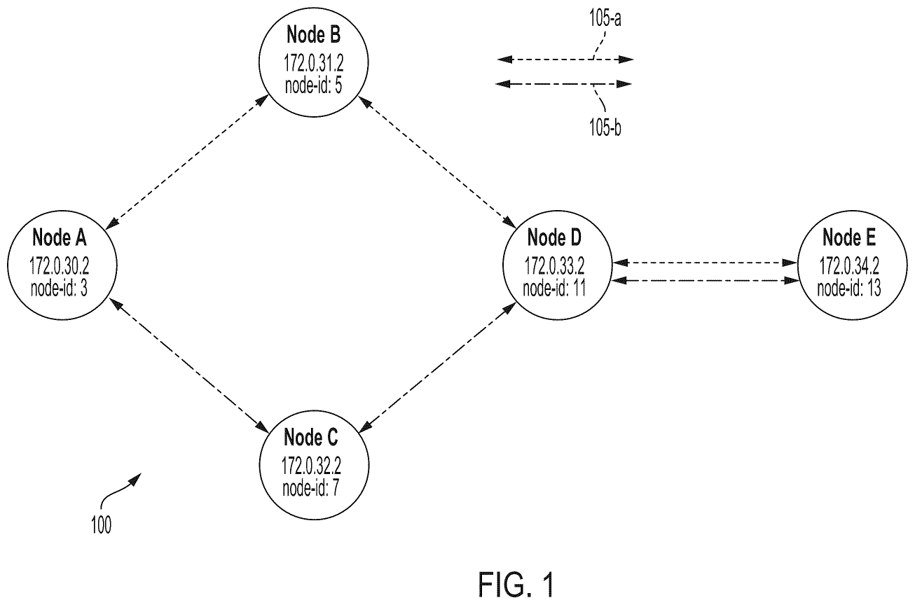

FIG. 1 shows an example 100 of how PPP works among a plurality of nodes in accordance with one or more embodiments of the present disclosure, where each node is represented by a circle. Each node has a unique prime number as an identifier (ID). When the distance vectors are created under any destination-based distance vector routing algorithm, prime path products are created as a product of all the prime numbers of the nodes on the path from potential sources to the destination. Based on the prime path products, the source knows the Quality of Service (QoS) cost and aggregate topology of the QoS-aware paths going through different nodes of the network towards the ultimate destination. Embodiments of the present disclosure may include representing the network as a network graph described herein.

In the examples described herein, the nodes may be referenced by a node name (e.g., node A, node B, and the like) for differentiating nodes illustrated in the figures, but the identifiers are examples, and embodiments of the present disclosure are not limited thereto.

In an example implementation, the systems and techniques described herein may include assigning each node a unique prime number as an identifier. For example, with reference to the example figures herein, the systems and techniques described herein may assign a node-id: 3 to Node A, assign a node-id: 5 to Node B, assign a node-id: 7 to Node C, assign a node-id: 11 to Node D, assign a node-id: 3 to Node A, assign a node-id: 3 to Node A, assign a node-id: 3 to Node A, and the like.

The systems and techniques described herein may include creating the distance vectors under any destination-based distance vector routing algorithm, and creating the distance vectors may include creating prime path products as a product of all the prime numbers of the nodes on the path from potential sources (e.g., Node A having a node-id: 3) to a destination (e.g., Node E having node-id: 13, Node F having node-id 17, Node G having node-id 19, or the like). Based on the prime path products, a given source (e.g., Node A having node-id: 3) may determine and know the Quality of Service (QoS) cost and aggregate topology of the QoS-aware paths 105 (e.g., for example, path 105-a and path 105-b) going through different nodes of the network towards the ultimate destination.

Each node of the network may be implemented by a respective computing device or computer system (e.g., distributed computer system 800, computer system 802, computer systems 804, computer systems 806) described herein.

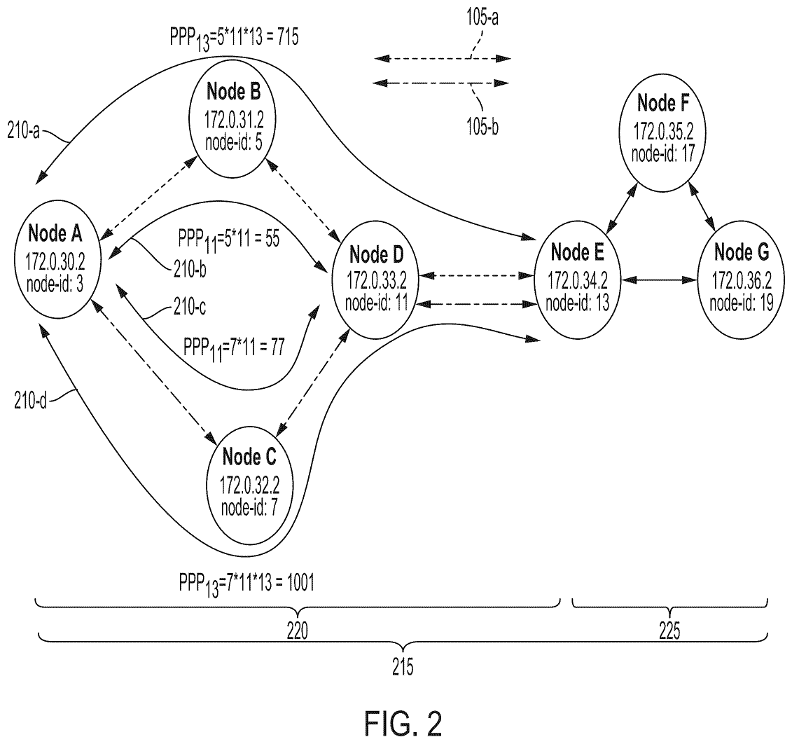

With reference now to FIG. 2, unique PPPs are assigned to uniquely prioritized flows 215. For example, a codebook distributed to each node assigns a PPP value to a Type of Service (TOS) value. As the distance vectors are created, the mapping of PPP to priority value from the TOS field can be applied, revoked or remapped. Each node can verify that if their node id is one of the factors of the PPP, they ought to reserve or provision the right interface (with the right next hop who is on the PPP) for certain priority flagged flow.

In an example implementation, the systems and techniques described herein with reference to path provisioning may include assigning unique PPPs to uniquely prioritized flows 215. In an example, the systems and techniques may include assigning a PPP₁₃=5*11*13=715 to path 210-a, assigning a PPP₁₁=5*11=55 to path 210-b, assigning a PPP₁₁=7*11*=77 to path 210-c, and assigning a PPP₁₃=7*11*13=1001 to path 210-d. The systems and techniques described herein may include assigning, via a codebook distributed to a given node (e.g., Node A having node-id: 3), a PPP value to each path 210 including the node.

The systems and techniques described herein may include assigning, via a codebook distributed to each node, a PPP value to a Type of Service (TOS) value. In an example, For example, for a case in which a pair of nodes are to send high priority data, the systems and techniques described herein may support reserving a path by including the in-use PPPs as part of the network discovery packet. Unlike TOS values, which may be used to communicate priority of data within a subset of the network, including the PPP value will allow for the entire network to be aware of which specific nodes are supporting a high priority transmission. Accordingly, for example, based on a PPP value included in a network discovery packet received at a node of the network, the system may be able to determine which specific nodes are supporting a high priority transmission.

In some aspects, as the distance vectors are created, the systems and techniques described herein may include applying, revoking, or remapping the mapping of PPP to priority value from the TOS field. For example, each node can verify whether the node identifier of the node is one of the factors of a given PPP. In an example, based on a given node (e.g., Node B having node-id: 5) verifying that the node identifier is one of the factors of a given PPP (e.g.,, PPP₁₃ assigned to path 210-a, or PPP₁₁ assigned to path 210-b), the node may reserve or provision the interface with a next hop (e.g., a next node, for example, Node D having node-id: 11) included on the PPP for a certain priority flagged flow.

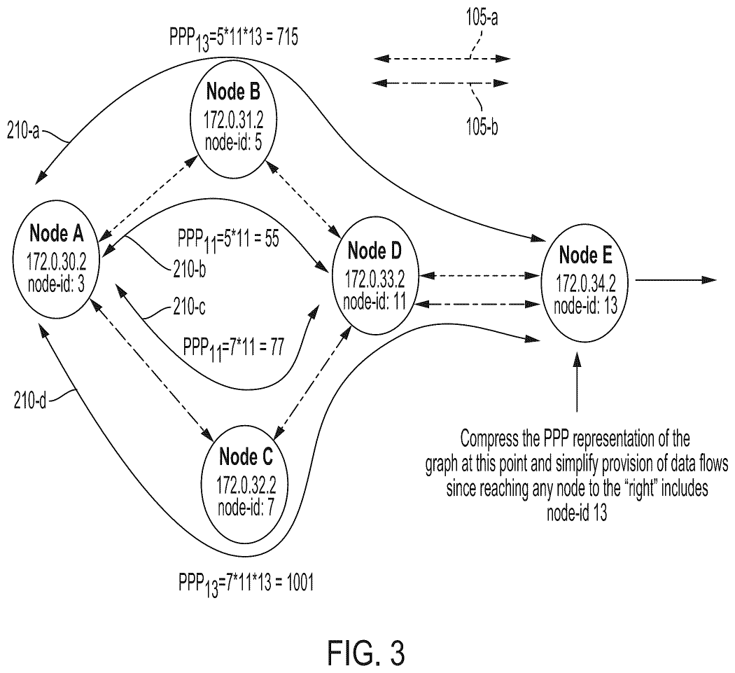

In some embodiments, the data flow of FIG. 2 and FIG. 3 can be simplified by utilizing a distance vector routing algorithm. With distance vector routing algorithm, the whole path provision does not have to be updated when a portion of the path 215 breaks down. In some aspects, for a case in which only the left hand-side of the network topology changes (e.g., if the path provision associated with portion 220 changes but other portions of the path 230 remain unchanged), embodiments of the present disclosure may include updating only the path provision to the left of Node E, and the right of the path provision can be summarized as stable and the same as before by representing as the path product from Node E to the destination. This makes path provision recovery post network partition or reformation efficient and fast.

In an example implementation, the systems and techniques described herein with reference to path provisioning may include applying a distance vector routing algorithm for cases in which a portion of a given path breaks down (e.g., due to a change in network topology). In an example, for a given data flow from node A (i.e., 172.0.30.2) to node G (i.e., 172.0.36.2), the systems and techniques described herein may include determining that a portion 220 (e.g., left hand-side of the network topology) spanning from node A (i.e., 172.0.30.2) to node G (i.e., 172.0.36.2) breaks down due to a change in network topology associated with the portion 220.

By applying a distance vector routing algorithm as described herein, the systems and techniques may include updating the portion 220 of the path 215 and corresponding data flow (rather than updating the entire path provision for path 215) in response to determining the portion 220 of the path 215 and corresponding data flow has broken down.

The systems and techniques described herein may further include summarizing portion 225 of the path 215 and corresponding data flow as stable and the same as before by representing as the path product from node E (having node-id: 13) to the destination. Accordingly, for example, summarizing portions of the path 215 and corresponding data flow as stable may provide increased efficiency and reduced processing time associated with path provision recovery post network partitioning or reformation.

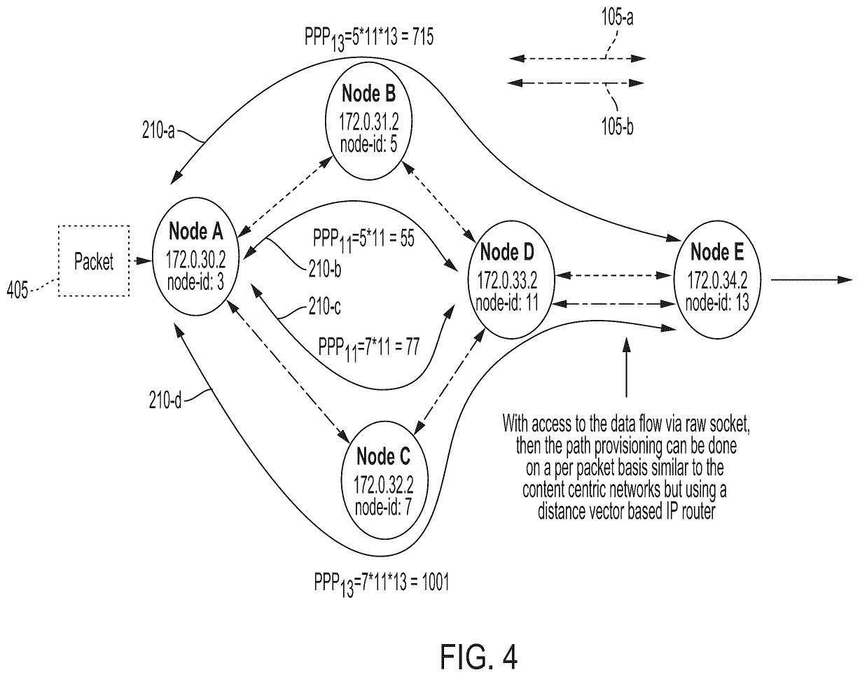

As shown in FIG. 4, assuming access to the data flow, embodiments of the present disclosure may include embedding PPP values in the IP header of a data packet 405 (e.g., an IP data packet) to traverse the network paths. Then, as packets (e.g., data packets 405) traverse the network paths with PPPs, the system and techniques described herein may keep dividing the PPP (as embedded in the IP header of the data packet 405) with the node identifier to update the PPP value. This allows multi-path routes to be provisioned for a target traffic flow, such as, for example, a very important traffic flow (e.g., a flow with message of high importance or a packet of high importance) as shown in FIG. 4.

Accordingly, for example, for cases in which the network is degraded such that only one path 105 (e.g., path 105-a) of the two provisioned is available, the data packet 405 still makes it to the final destination using the available path.

Accordingly, for example, for cases in which both paths (e.g., path 105-a, path 105-b) are available, a data packet 405 may take one of the paths and let the preceding node (i.e., Node D having node-id: 11) know which path the data packet 405 took for future re-provisioning or in, the case of a link loss, help detect the outage quickly.

In an example implementation, the systems and techniques described herein with reference to path provisioning may include embedding a PPP value in the header of a data packet 405 to traverse the network paths 205. For example, with reference to FIG. 4, the systems and techniques described herein may include embedding a PPP value of 715 (e.g., associated with path 210-a) and a PPP value of 1001 (e.g., associated with path 210-d) in the IP header of the data packet 405.

As a data packet 405 traverses the network paths with PPPs, the system and techniques described herein may include dividing (e.g., at a leaf node, for example, Node E) the PPP with the node identifier of a node traversed by the data packet 405 to update the PPP value in the IP header of the data packet 405.

For example, for a case in which the data packet 405 traverses through Node A and Node B along the path 105-a, the systems and techniques described herein may include recording, to the data packet 405, the node identifiers ‘3’ and ‘5’ respectively corresponding to Node A and Node B. At Node D (preceding node), the systems and techniques described herein may include processing the node identifiers ‘3’ and ‘5’ and determining, based on the processing, that the data packet 405 traversed through Node A and Node B along the path 105-a. Additionally, or alternatively, the systems and techniques described herein may include updating the IP header of the data packet 405 at each node (e.g., based on the node identifier associated with the node), and forwarding the data packet 405 with the updated IP header.

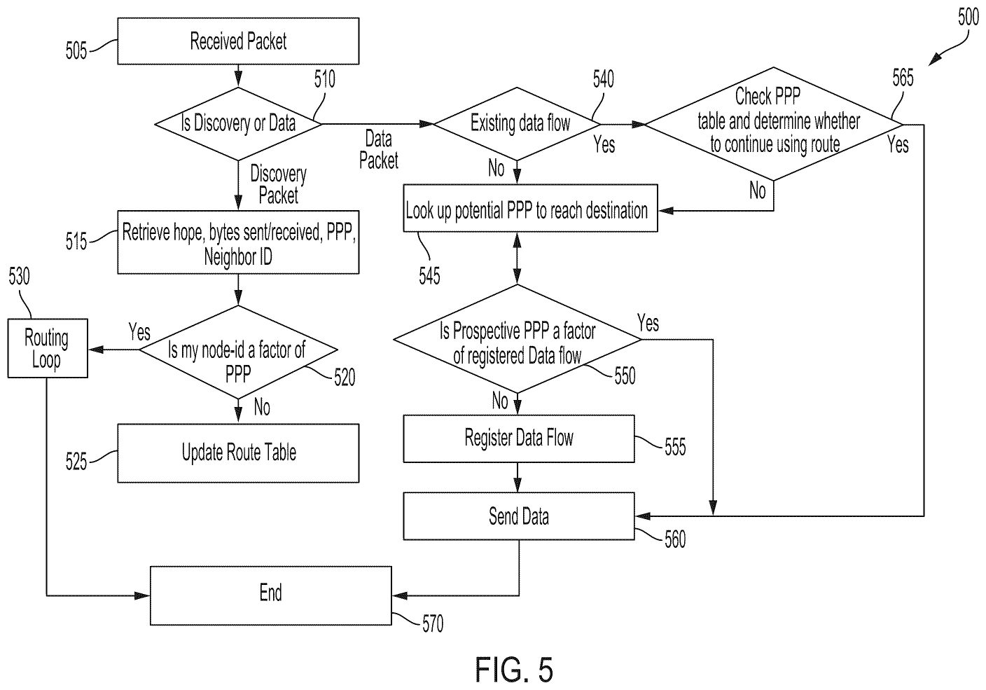

FIG. 5 illustrates an example flowchart of a method 500 supportive of path provisioning using PPP in accordance with one or more embodiments of the present disclosure. The method 500 may be implemented by the example aspects of a system 800 as described herein.

Some or all of the methods described herein with reference to path provisioning with PPP are shown in the flow chart of FIG. 5.

At 505, the method 500 may include receiving, at a node (e.g., Node B of FIG. 2, or the like), a packet.

At 510, the method 500 may include determining, at the node, whether the packet is a discovery packet or a data packet.

In response to determining the packet is a discovery packet, at 515, the method 500 may include retrieving, at the node, information (e.g., hops, bytes sent/received, PPP information, and neighbor ID) based on data included in the discovery packet.

At 520, the method 500 may include determining, at the node, based on the information retrieved at 515, whether the node ID associated with the node is a factor of the PPP included in the information.

In response to determining at 515 that the node ID associated with the node is not a factor of the PPP included in the information (‘No’), the method 500 may proceed to 525. At 525, the method 500 may include updating a routing table associated with the network.

Alternatively, in response to determining at 515 that the node ID associated with the node is a factor of the PPP included in the information (‘Yes’), the method 500 may proceed to a routing loop at 530. The routing loop is an artifact that may occur when a series of nodes believe a destination is reachable via a path that has already been covered/traversed during the transmission. For example, the method 500 may include detecting whether the one or more nodes have determined the destination is reachable via the path that has already been covered/traversed during the transmission (e.g., decision at 520). For the case in which the one or more nodes have determined the destination is reachable via the path (e.g., ‘Yes’), the method 500 may include recognizing that the node identifier of the current node along with the received path's PPP is already a part of the transmission path (state 530). The method 500 may proceed to discarding the path, and the procedure reaches terminal state and ends at 570.

For example, for a case in which the PPP associated with the discovery packet is 715, Node B may determine, based on the identifier ‘5’ of Node B having node-id: 5, that Node B is a factor of the PPP of 715 (i.e., 5*11*13=715). At 530, the Node B may forward the discovery packet to the next node (e.g., Node D) in the routing loop.

In response to determining at 510 that the packet is a data packet, the method 500 may proceed to 540. At 540, the method 500 may include determining whether the packet is part of an existing data flow (i.e., a registered data flow).

In response to determining at 540 that the packet is not part of an existing data flow (‘No’), the method 500 may proceed to 545. At 545, the method 500 may include looking up potential PPPs (i.e., and corresponding candidate paths 210 associated with the PPPs) for reaching a destination. In some examples, the method 500 may include looking up the potential PPPs (i.e., and corresponding candidate paths 210) from a routing table described herein.

At 550, the method 500 may include determining whether a prospective PPP identified at 545 is a factor of a registered data flow (e.g., a registered data flow 210).

In response to determining the prospective PPP identified at 545 is not a factor of a registered data flow (‘No’), the method 500 may proceed to 555. At 555, the method 500 may include registering a data flow in association with the PPP identified at 545 in association with the packet.

Alternatively, in response to determining the prospective PPP identified at 545 is a factor of a registered data flow (‘Yes’), the method 500 may proceed to 560.

At 560, the method 500 may include sending data. For example, at 560, the method 500 may include transmitting the packet to a destination associated with the packet.

In some aspects, in response to determining at 540 that the packet is part of an existing data flow (‘Yes’), the method 500 may proceed to 565. At 565, the method 500 may include determining whether to continue using an existing route associated with the existing data flow. For example, the method 500 may include determining whether to continue the existing route by referencing (i.e., checking) a PPP table. The PPP table may be an example of a routing table as described herein.

In response to determining at 565 to continue using the existing route (‘Yes’), the method 500 may proceed to 560 and accordingly send data (i.e., transmit the packet).

Alternatively, for example, in response to determining at 565 to not continue using the existing route (‘No’), the method 500 may proceed to 545 and/or 550.

At 570, the method 500 may end.

The above systems/methods can provide a singular value that can condense aspects of a network, as well as provide an easy method of “reserving” paths in a network.

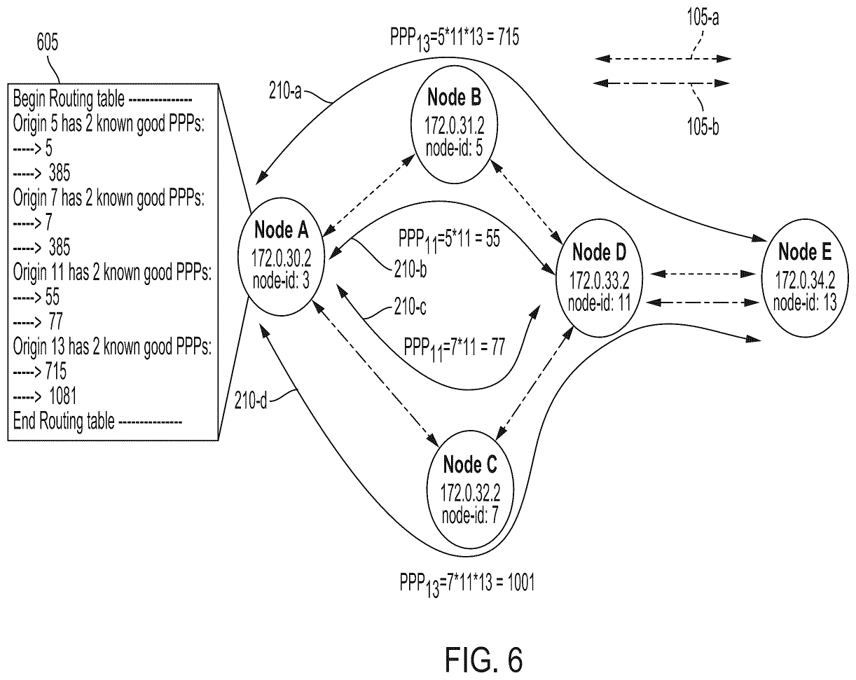

FIG. 6 shows an example of how load balancing with PPP can be implemented in accordance with one or more embodiments of the present disclosure. Using PPVs along with each path's QoS measures, a source can assign different disjoint paths to different flows. If the greatest common divisor (GCD) of two PPV paths is the destination node, then there exists two distinct paths going to the destination node. If the GCD of two PPV paths is a prime number or set of prime numbers, there exists distinct paths but with intersection points identified along the way. If union of two PPV paths create the largest subset of the network graph among any other two PPVs, then these paths load balances the flows from the source to the destination the most. Using a simple hash function with a uniform distribution, each flow can be assigned to distinct paths that balances the load across paths and flows in a distributed manner.

Aspects of implementing load balancing with PPP may be implemented using a routing table 605. For example, consider an example case where data is actively being transmitted using path 210-b. The routing table 605 provides a format based on which the systems and techniques described herein may identify that the PPP ‘55’ of path 210-b is a factor of the PPP ‘715’ of path 210-a. Accordingly, for example, the systems and techniques described herein may include balancing the traffic load by selecting and using a route having a PPP that is not a multiple of the PPP ‘55’ of path 210-b. In an example, the systems and techniques described herein may include balancing the traffic load by selecting and using path 210-c having a PPP of ‘77’.

In an example implementation with respect to load balancing, the systems and techniques described herein may include assigning, by a source (e.g., Node A), different disjoint paths 210 (e.g., path 210-a through path 210-d) to different flows 215 using PPVs along with QoS measures of each path 210.

For example, the source (e.g., Node A) may determine whether two or more distinct paths 210 exist which lead to a destination node (e.g., Node E). The source may determine whether two or more distinct paths 210 exist, based on the greatest common divisor (GCD) of PPV paths 210.

In an example, the source may determine that, for reaching the destination node (e.g., Node E having a node-id: 13), the number ‘13’ is the GCD among path 210-a (having a PPP₁₃=5*11*13=715) and path 210-d (having a PPP₁₃=7*11*13=1001). Accordingly, for example, the source may conclude that two distinct paths 210 (e.g., path 210-a, path 210-d) exist which lead to the destination node. Further, for example, the source may conclude that path 210-b (having a PPP₁₁=5*11=55) and path 210-c (having a PPP₁₁=7*11*=77) are not paths for arriving at the destination node, as the GCD among path 210-b and path 210-c is the number ‘11’, which is different from the number ‘13’ associated with node-id: 13 of the destination node.

In another example aspect, in response to determining the GCD of two PPV paths 210 is a prime number or set of prime numbers, the source (e.g., Node A) may conclude there exists distinct paths but with intersection points identified along the way. For example, the source may conclude that path 210-a (having a PPP₁₃=5*11*13=715) and path 210-d (having a PPP₁₃=7*11*13=1001) are distinct paths, but with an intersection point at Node B for path 210-b, an intersection point at Node C for path 210-d, and a common intersection point at Node D for both path 210-b and path 210-d. In another example, the source may conclude that path 210-b (having a PPP₁₁=5*11=55) and path 210-c (having a PPP₁₁=7*11*=77) are distinct paths, but with an intersection point at Node B for path 210-b and an intersection point at Node C for path 210-d.

In another example aspect, the source (e.g., Node A) may determine, from among PPV paths 210 which are included in a network graph and span from the source to a destination (e.g., Node E), a pair of PPV paths 210 for which the union of the two PPV paths 210 creates the largest subset of the network graph among any other pairs of PPV paths 210 which span from the source to the destination. For example, the source may identify that path 210-a (having a PPP₁₃=5*11*13=715) and path 210-d (having a PPP₁₃=7*11*13=1001) create the largest subset of the network graph among any other pairs of PPV paths 210 (not illustrated) which span from the source to the destination. Accordingly, for example, the source may determine that path 210-a and path 210-d provide the greatest amount of load balancing of data flow from the source to the destination compared to other pairs of PPV paths 210 (not illustrated) which span from the source to the destination.

Accordingly, for example, the source may select and use path 210-a and path 210-d for exchanging data packets with the destination (e.g., transmitting data packets, receiving data packets) based on the amount of load balancing the path 210-a and path 210-d are capable of providing.

Using a simple hash function with a uniform distribution, the systems and techniques described herein include assigning (e.g., by the source, for example, Node A) each data flow to distinct paths 210 in a manner which balances the load across paths 210 and data flows in a distributed manner.

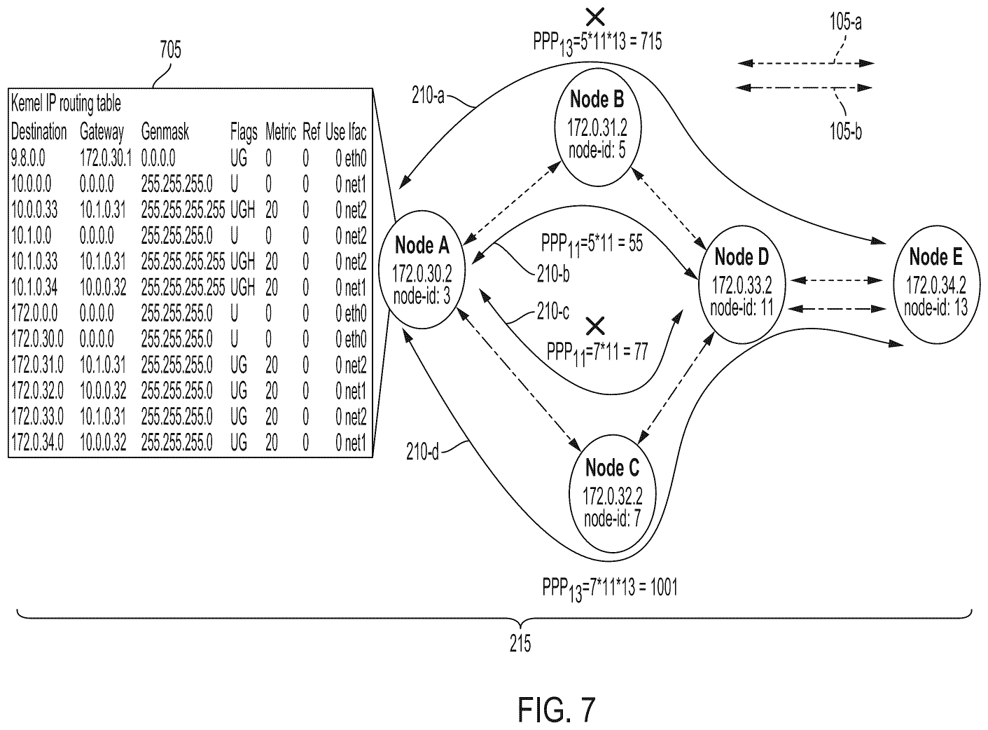

With further reference to FIG. 7, distance vector protocols may not be great at load balancing because as distance vector protocols only calculate the overall cost to the destination and not the link state. Link state protocols keep track of the global topology to make optimized load balancing decisions at the cost of maintaining the global topology database.

In accordance with one or more embodiments of the present disclosure, PPP described herein allows any distance vector protocol to look across the top two-to-three paths per (source, destination) flow and organize routes per flow across all (source, destination) pairs to load balance in the most efficient way, without needing to maintain the global topology.

Aspects of implementing load balancing described with reference to FIG. 7 may be implemented using a routing table 705 (e.g., a Kernel IP routing table). For example, routing table 705 reflects the routes that any application running on the target system may use when sending data. In some aspects, the routes are a reflection of PPP's load balancing by ensuring that path 210-b and path 210-d are chosen.

In an example implementation with respect to load balancing, the systems and techniques described herein may include, for a given data flow, applying a distance vector protocol in association with identifying a set of paths 210 (e.g., the top two or three paths 210) having a highest capability for balancing loads (e.g., as described with reference to FIG. 6) and determining, from among the set the set of paths 210, routes which balance the load associated with the data flow. For a given data flow, the systems and techniques described herein may include organizing routes (e.g., using paths 210 and sub-paths included in the paths 210) for the data flow across all source/destination pairs by referencing the PPPs and node identifiers as stored in a routing table described herein. Accordingly, for example, in using the PPPs, node identifiers, and routing table described herein, the systems and techniques described herein may support effective load balancing without maintaining a global topology (network topology) associated with a given network.

The systems and techniques described herein provide technical advantages and improvements compared to some other approaches. For example, the use of GCD factorization as described herein supports effective determination (e.g., by a source node) of whether a given path 210 (e.g., path 210-b) is a subset of another path 210 (e.g., path 210-a) through the use of GCDs among the paths 210 and respective node identifiers of nodes included in the paths 210. The use of GCD factorization and routing using routing tables including such information provide a reduction in computational overhead compared to routing methods which are based on hashing. For example, the PPPs and node identifiers stored described herein may be implemented as precomputed values accessible via the routing table, which is different from hashing approaches.

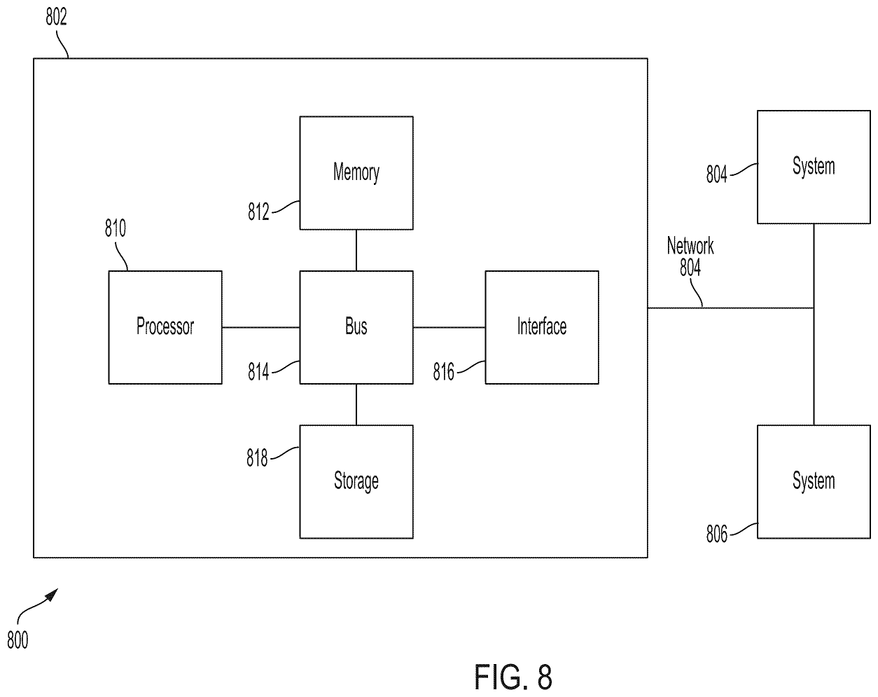

FIG. 8 is a block diagram of a distributed computer system 800, in which various aspects and functions discussed above may be practiced. The distributed computer system 800 may include one or more computer systems. For example, as illustrated, the distributed computer system 800 includes three computer systems 802, 804 and 806. As shown, the computer systems 802, 804 and 806 are interconnected by, and may exchange data through, a communication network 808. The network 808 may include any communication network through which computer systems may exchange data. To exchange data via the network 808, the computer systems 802, 804, and 806 and the network 808 may use various methods, protocols and standards including, among others, token ring, Ethernet, Wireless Ethernet, Bluetooth, radio signaling, infra-red signaling, TCP/IP, UDP, HTTP, FTP, SNMP, SMS, MMS, SS7, JSON, XML, REST, SOAP, CORBA IIOP, RMI, DCOM and Web Services.

According to some embodiments, the functions and operations discussed herein for path provisioning and load balancing can be executed on computer systems 802, 804 and 806 individually and/or in combination. For example, the computer systems 802, 804, and 806 support, for example, participation in a collaborative network. In one alternative, a single computer system (e.g., 802) can implement path provisioning and load balancing described herein. The computer systems 802, 804 and 806 may include personal computing devices such as cellular telephones, smart phones, tablets, “phablets,” etc., and may also include desktop computers, laptop computers, etc.

Various aspects and functions in accordance with embodiments discussed herein may be implemented as specialized hardware or software executing in one or more computer systems including the computer system 802 shown in FIG. 4. In some embodiments, computer system 802 is a personal computing device specially configured to execute the processes and/or operations discussed above. As depicted, the computer system 802 includes at least one processor 810 (e.g., a single core or a multi-core processor), a memory 812, a bus 814, input/output interfaces (e.g., 816) and storage 818. The processor 810, which may include one or more microprocessors or other types of controllers, can perform a series of instructions that manipulate data. As shown, the processor 810 is connected to other system components, including a memory 812, by an interconnection element (e.g., the bus 814).

The memory 812 and/or storage 818 may be used for storing programs and data during operation of the computer system 802. For example, the memory 812 may be a relatively high performance, volatile, random access memory such as a dynamic random access memory (DRAM) or static memory (SRAM). In addition, the memory 812 may include any device for storing data, such as a disk drive or other non-volatile storage device, such as flash memory, solid state, or phase-change memory (PCM). In further embodiments, the functions and operations discussed with respect to path provisioning and load balancing can be embodied in an application that is executed on the computer system 802 from the memory 812 and/or the storage 818. For example, the application can be made available through an “app store” for download and/or purchase. Once installed or made available for execution, computer system 802 can be specially configured to execute the functions associated with path provisioning and load balancing.

Computer system 802 also includes one or more interfaces 816 such as input devices (e.g., camera for capturing images), output devices and combination input/output devices. The interfaces 816 may receive input, provide output, or both. The storage 818 may include a computer-readable and computer-writeable nonvolatile storage medium in which instructions are stored that define a program to be executed by the processor. The storage 818 also may include information that is recorded, on or in, the medium, and this information may be processed by the application. A medium that can be used with various embodiments may include, for example, optical disk, magnetic disk or flash memory, SSD, among others. Further, aspects and embodiments are not to a particular memory system or storage system.

In some embodiments, the computer system 802 may include an operating system that manages at least a portion of the hardware components (e.g., input/output devices, touch screens, cameras, etc.) included in computer system 802. One or more processors or controllers, such as processor 810, may execute an operating system which may be, among others, a Windows-based operating system (e.g., Windows NT, ME, XP, Vista, 7, 8, or RT) available from the Microsoft Corporation, an operating system available from Apple Computer (e.g., MAC OS, including System X), one of many Linux-based operating system distributions (for example, the Enterprise Linux operating system available from Red Hat Inc.), a Solaris operating system available from Oracle Corporation, or a UNIX operating systems available from various sources. Many other operating systems may be used, including operating systems designed for personal computing devices (e.g., iOS, Android, etc.) and embodiments are not limited to any particular operating system.

The processor and operating system together define a computing platform on which applications (e.g., “apps” available from an “app store”) may be executed. Additionally, various functions for generating and manipulating images may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed components, or any combination thereof. Various embodiments may be implemented in part as MATLAB functions, scripts, and/or batch jobs. Thus, the invention is not limited to a specific programming language and any suitable programming language could also be used.

Although the computer system 802 is shown by way of example as one type of computer system upon which various functions for path provisioning and load balancing may be practiced, aspects and embodiments are not limited to being implemented on the computer system, shown in FIG. 8. Various aspects and functions may be practiced on one or more computers or similar devices having different architectures or components than that shown in FIG. 8.

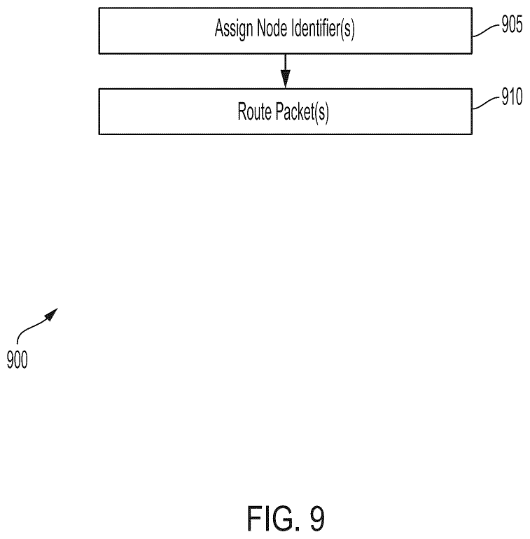

FIG. 9 illustrates an example flowchart of a method 900 in accordance with one or more embodiments of the present disclosure. The method 900 may be implemented by the example aspects of a system 800 as described herein.

At 905, the method 900 includes assigning, with respect to each node of the set of nodes, a node identifier including a prime number unique to the node.

At 910, the method 900 includes routing a packet from a source node of the set of nodes to a destination node of the set of nodes, based on one or more of the node identifiers.

In some aspects, the method 900 may include generating distance vectors associated with candidate paths from the source node to the destination node, where generating the distance vectors is based on prime numbers respectively associated with candidate nodes which are included in the set of nodes and included in the candidate paths, where routing the packet is based on the distance vectors.

In some aspects, the method 900 may include determining, for each candidate path of the candidate paths, a prime path product based on the prime numbers respectively associated with the candidate nodes included in the candidate path, where the distance vectors associated with the candidate paths are based on the prime path products associated with the candidate paths.

In some aspects, the method 900 may include determining, for each candidate path of the candidate paths, a quality of service cost and a topology based on the prime path product associated with the candidate path, where routing the packet is based on the quality of service costs, the topologies, or both of the candidate paths.

In some aspects, the method 900 may include: determining, for each candidate path of candidate paths from the source node to the destination node, a prime path product based on the prime numbers respectively associated with the candidate nodes included in the candidate path; and determining, from among the candidate paths, a set of load balancing paths configured to provide a greatest amount of load balancing of data flow from the source node to the destination node, where routing the packet includes routing the packet from the source node to the destination node, via one or more load balancing paths of the set of load balancing paths.

In some aspects, the method 900 may include: embedding a prime path product value in a header of the packet; modifying the prime path product value in the header of the packet, based on the node identifier of a node via which the packet traverses; and maintaining the network based on the modified prime path product value.

In some aspects, the method 900 may include: receiving, at a node of the set of nodes, the packet; retrieving, in response to determining the packet is a discovery packet, a prime path product associated with the packet; determining, at the node, whether the prime number included in the node identifier associated with the node is a factor of the prime path product; and one of: updating a routing table associated with the network, in response to determining the prime number is a factor of the prime path product; or proceeding to a routing loop associated with routing the packet, in response to determining the prime number is not a factor of the prime path product.

In some aspects, the method 900 may include: receiving, at a node of the set of nodes, the packet; determining, in response to determining the packet is a data packet, whether the packet is part of an existing data flow; determining, in response to determining the packet is part of the existing data flow, whether to continue using an existing route associated with the existing data flow; and routing the packet using the existing route or a different route, based on the determination of whether to continue using the existing route.

In some aspects, the method 900 may include: receiving, at a node of the set of nodes, the packet; determining, in response to determining the packet is a data packet, whether the packet is part of an existing data flow; determining, in response to determining the packet is not part of the existing data flow, one or more candidate paths for reaching the destination node, where determining the one or more candidate paths is based on respective prime path products associated with the one or more candidate paths; registering a data flow associated with the one or more candidate paths; and routing the packet based on the data flow and the one or more candidate paths.

In some aspects, the node identifiers are stored to a routing table.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

Based on the above, it shall be understood that providing a singular value can condense aspects of a network, as well as provide an easy method of checking whether two potential routes overlap with one another thereby causing collisions/congestion.

Further, either alone or in combination, the above systems and methods can change how a computing device organizes/sends/receives packets in a wireless ad hoc network. This can include finding shortest or best QoS routes and/or reducing collisions/congestion.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system comprising:
a network comprising a set of nodes;
a processor and a memory, wherein the memory comprises instructions stored thereon that, when executed by the processor, cause the processor to perform operations comprising:
assigning, with respect to each node of the set of nodes, a node identifier comprising a prime number unique to the node; and
routing a packet from a source node of the set of nodes to a destination node of the set of nodes, based on one or more of the node identifiers.

2. The system of claim 1, wherein the operations further comprise:
generating distance vectors associated with candidate paths from the source node to the destination node, wherein generating the distance vectors is based on prime numbers respectively associated with candidate nodes which are comprised in the set of nodes and comprised in the candidate paths,
wherein routing the packet is based on the distance vectors.

3. The system of claim 2, wherein the operations further comprise:
determining, for each candidate path of the candidate paths, a prime path product based on the prime numbers respectively associated with the candidate nodes comprised in the candidate path,
wherein the distance vectors associated with the candidate paths are based on the prime path products associated with the candidate paths.

4. The system of claim 3, wherein the operations further comprise:
determining, for each candidate path of the candidate paths, a quality of service cost and a topology based on the prime path product associated with the candidate path,
wherein routing the packet is based on the quality of service costs, the topologies, or both of the candidate paths.

5. The system of claim 1, wherein the operations further comprise:
determining, for each candidate path of candidate paths from the source node to the destination node, a prime path product based on the prime numbers respectively associated with the candidate nodes comprised in the candidate path; and
determining, from among the candidate paths, a set of load balancing paths configured to provide a greatest amount of load balancing of data flow from the source node to the destination node,
wherein routing the packet comprises routing the packet from the source node to the destination node, via one or more load balancing paths of the set of load balancing paths.

6. The system of claim 1, wherein the operations further comprise:
embedding a prime path product value in a header of the packet;
modifying the prime path product value in the header of the packet, based on the node identifier of a node via which the packet traverses; and
maintaining the network based on the modified prime path product value.

7. The system of claim 1, wherein the operations further comprise:
receiving, at a node of the set of nodes, the packet;
retrieving, in response to determining the packet is a discovery packet, a prime path product associated with the packet;
determining, at the node, whether the prime number comprised in the node identifier associated with the node is a factor of the prime path product; and
one of:
updating a routing table associated with the network, in response to determining the prime number is a factor of the prime path product; or
proceeding to a routing loop associated with routing the packet, in response to determining the prime number is not a factor of the prime path product.

8. The system of claim 1, wherein the operations further comprise:
receiving, at a node of the set of nodes, the packet;
determining, in response to determining the packet is a data packet, whether the packet is part of an existing data flow;
determining, in response to determining the packet is part of the existing data flow, whether to continue using an existing route associated with the existing data flow; and
routing the packet using the existing route or a different route, based on the determination of whether to continue using the existing route.

9. The system of claim 1, wherein the operations further comprise:
receiving, at a node of the set of nodes, the packet;
determining, in response to determining the packet is a data packet, whether the packet is part of an existing data flow;
determining, in response to determining the packet is not part of the existing data flow, one or more candidate paths for reaching the destination node, wherein determining the one or more candidate paths is based on respective prime path products associated with the one or more candidate paths;
registering a data flow associated with the one or more candidate paths; and
routing the packet based on the data flow and the one or more candidate paths.

10. The system of claim 1, further comprising a routing table comprising the node identifiers assigned with respect to the set of nodes.

11. A method comprising:
assigning, with respect to each node of the set of nodes, a node identifier comprising a prime number unique to the node; and
routing a packet from a source node of the set of nodes to a destination node of the set of nodes, based on one or more of the node identifiers.

12. The method of claim 11, further comprising:
generating distance vectors associated with candidate paths from the source node to the destination node, wherein generating the distance vectors is based on prime numbers respectively associated with candidate nodes which are comprised in the set of nodes and comprised in the candidate paths,
wherein routing the packet is based on the distance vectors.

13. The method of claim 11, further comprising:
determining, for each candidate path of the candidate paths, a prime path product based on the prime numbers respectively associated with the candidate nodes comprised in the candidate path,
wherein the distance vectors associated with the candidate paths are based on the prime path products associated with the candidate paths.

14. The method of claim 11, further comprising:
determining, for each candidate path of the candidate paths, a quality of service cost and a topology based on the prime path product associated with the candidate path,
wherein routing the packet is based on the quality of service costs, the topologies, or both of the candidate paths.

15. The method of claim 11, further comprising:
determining, for each candidate path of candidate paths from the source node to the destination node, a prime path product based on the prime numbers respectively associated with the candidate nodes comprised in the candidate path; and
determining, from among the candidate paths, a set of load balancing paths configured to provide a greatest amount of load balancing of data flow from the source node to the destination node,
wherein routing the packet comprises routing the packet from the source node to the destination node, via one or more load balancing paths of the set of load balancing paths.

16. The method of claim 11, further comprising:
embedding a prime path product value in a header of the packet;
modifying the prime path product value in the header of the packet, based on the node identifier of a node via which the packet traverses; and
maintaining the network based on the modified prime path product value.

17. The method of claim 11, further comprising:
receiving, at a node of the set of nodes, the packet;
retrieving, in response to determining the packet is a discovery packet, a prime path product associated with the packet;
determining, at the node, whether the prime number comprised in the node identifier associated with the node is a factor of the prime path product; and
one of:
updating a routing table associated with the network, in response to determining the prime number is a factor of the prime path product; or
proceeding to a routing loop associated with routing the packet, in response to determining the prime number is not a factor of the prime path product.

18. The method of claim 11, further comprising:
receiving, at a node of the set of nodes, the packet;
determining, in response to determining the packet is a data packet, whether the packet is part of an existing data flow;
determining, in response to determining the packet is part of the existing data flow, whether to continue using an existing route associated with the existing data flow; and
routing the packet using the existing route or a different route, based on the determination of whether to continue using the existing route.

19. The method of claim 11, further comprising:
receiving, at a node of the set of nodes, the packet;
determining, in response to determining the packet is a data packet, whether the packet is part of an existing data flow;
determining, in response to determining the packet is not part of the existing data flow, one or more candidate paths for reaching the destination node, wherein determining the one or more candidate paths is based on respective prime path products associated with the one or more candidate paths;
registering a data flow associated with the one or more candidate paths; and
routing the packet based on the data flow and the one or more candidate paths.

20. The method of claim 11, wherein the node identifiers are stored to a routing table.
